(19) United States
(12) Patent Application Publication
(10) Pub. No.: US 2023/0260220 A1
(43) Pub. Date: Aug. 17, 2023

(54) INFORMATION PROCESSOR, INFORMATION PROCESSING METHOD, AND STORAGE MEDIUM

(71) Applicant: SONY GROUP CORPORATION, TOKYO (JP)

(72) Inventors: ATSUSHI ISHIHARA, TOKYO (JP); HIROTAKE ICHIKAWA, TOKYO (JP)

(21) Appl. No.: 18/002,654

(22) PCT Filed: May 10, 2021
(86) PCT No.: PCT/JP2021/017712

§ 371 Date: Dec. 20, 2022

(30) Foreign Application Priority Data
Jun. 30, 2020 (JP) 2020-113039

(51) Int. Cl. G06T 19/00; G09G 5/377; G06V 10/74; G06T 5/50

(52) U.S. Cl. CPC G06T 19/006; G09G 5/377; G06V 10/761; G06T 5/50; G06T 2207/20221

(57) ABSTRACT

[Problem] To provide an information processor, an information processing method, and a storage medium that can properly reduce a display delay when a virtual object is superimposed on a field of view on a video see-through display.

[Solution] The information processor includes a display control unit, wherein the display control unit controls the video see-through display configured to display a captured image that is acquired by an imaging unit, the display control unit superimposes the virtual object on a first captured image if a load of recognition of a real space based on a predetermined captured image is a first load, the virtual object being drawn on the basis of recognition of the real space, and the display control unit superimposes the virtual object on a second captured image if the load of the recognition is a second load greater than the first load, the second captured image being acquired before the first captured image.

### TECHNICAL FIELD

The present disclosure relates to an information processor, an information processing method, and a storage medium.

### BACKGROUND ART

Various techniques for viewing a merge of a real space and a virtual space have been developed in recent years. For example, augmented reality (AR) has been developed as a technique for displaying a virtual space image (will be referred to as a virtual object) superimposed on a real space that is directly viewed. A device for implementing augmented reality is, for example, an optical see-through head mounted display (hereinafter referred to as “HMD”).

For example, PTL 1 describes that a virtual object linked with an object in a real space is displayed in an AR technique. Specifically, the position or orientation of an object in a real space is recognized, and then the virtual object is displayed according to the recognition result. In PTL 1, a virtual object is displayed while a change of the position or orientation of an object in a real space is predicted. Furthermore, in PTL 1, if the display is disturbed, for example, the display position or orientation of a virtual object is displaced due to a time lag from an acquisition time of prediction information to a display time of the virtual object, from a position or orientation to be displayed, the displacement of the display is made less noticeable by blurring the display position with motion blur or the like.

PTL 2 also describes that when a user wearing an HMD or an object in a real space moves in an AR technique, the position and orientation of a virtual object are set according to the motion, thereby reducing unnaturalness caused by a display delay. Specifically, in PTL 2, the position and orientation of an HMD are predicted, and then a virtual object image is deformed according to the prediction, so that a user is less likely to sense a displacement of a superimposition position and a display delay. In PTL 2, a raster scan display is used and is divided into a plurality of slices (display areas) perpendicularly to the scanning direction of a raster scan. The slices are sequentially displayed according to a scan. In other words, the HMD of PTL 2 includes a display having a plurality of adjacent display areas with different timings of display. Most immediately before the display of each of the slices, the HMD of PTL 2 predicts the position and orientation of the HMD at the time of displaying each of the slices and deforms an image for each of the slices according to the prediction result, so that a user is less likely to sense a displacement of a superimposition position and a display delay.

### CITATION LIST

### Patent Literature

### [PTL 1]

WO 2017/047178

### [PTL 2]

WO 2019/181263

### SUMMARY

### Technical Problem

The related art does not examine the problems of a display delay in a user's field of view when a virtual object is superimposed on a video see-through display.

Hence, the present disclosure proposes an information processor, an information processing method, and a storage medium that can properly reduce a display delay when a virtual object is superimposed on a field of view on a video see-through display.

### Solution to Problem

The present disclosure proposes an information processor including a display control unit, wherein the display control unit controls a video see-through display configured to display a captured image that is acquired by an imaging unit, the display control unit superimposes a virtual object on a first captured image if a load of recognition of a real space based on a predetermined captured image is a first load, the virtual object being drawn on the basis of recognition of the real space, and the display control unit superimposes the virtual object on a second captured image if the load of the recognition is a second load greater than the first load, the second captured image being acquired before the first captured image.

The present disclosure proposes an information processing method including: causing a processor to perform display control of a video see-through display configured to display a captured image that is acquired by an imaging unit; causing the processor to perform display control to superimpose a virtual object on a first captured image if a load of recognition of a real space based on a predetermined captured image is a first load, the virtual object being drawn on the basis of recognition of the real space; and causing the processor to perform display control to superimpose the virtual object on a second captured image if the load of the recognition is a second load greater than the first load, the second captured image being acquired before the first captured image.

The present disclosure proposes a storage medium in which a program is stored, the program causing a computer to function as a display control unit, wherein the display control unit controls a video see-through display configured to display a captured image that is acquired by an imaging unit, the display control unit superimposes a virtual object on a first captured image if a load of recognition of a real space based on a predetermined captured image is a first load, the virtual object being drawn on the basis of recognition of the real space, and the display control unit superimposes the virtual object on a second captured image if the load of the recognition is a second load greater than the first load, the second captured image being acquired before the first captured image.

### BRIEF DESCRIPTION OF DRAWINGS

FIG. 1 is a block diagram illustrating a hardware configuration example of an information processor according to an embodiment of the present disclosure.

FIG. 2 is an explanatory drawing illustrating unnaturalness caused by a display delay of a virtual object.

FIG. 3 is a timing chart indicating the flow of a series of processing to explain a display delay of the virtual object.

FIG. 4 is a flowchart indicating the flow of a series of processing to explain display control performed by the information processor according to the present embodiment.

FIG. 5 is a flowchart indicating an example of the flow of display control performed by the information processor according to the present embodiment.

FIG. 6 is an explanatory drawing of a superimposition stop line and a judgement criterion element for switching control according to the present embodiment.

FIG. 7 is a flowchart indicating an example of a flow of switching during low delay according to the present embodiment.

FIG. 8 is a flowchart indicating an example of a flow of switching during high delay according to the present embodiment.

FIG. 9 is a timing chart for explaining the switching of a view image over a predetermined number of frames upon switching from high delay to low delay according to the present embodiment.

FIG. 10 is a timing chart for explaining the switching of a view image over a predetermined number of frames upon switching from low delay to high delay according to the present embodiment.

FIG. 11 is a timing chart for explaining quick switching of a view image upon switching from high delay to low delay according to the present embodiment.

FIG. 12 is a timing chart for explaining quick switching of a view image upon switching from low delay to high delay according to the present embodiment.

FIG. 13 is a timing chart indicating an example of the frequency of update in recognition when a three-dimensional object recognition algorithm is used according to the present embodiment.

FIG. 14 is a timing chart indicating an example of the frequency of update in recognition when a two-dimensional object recognition algorithm is used according to the present embodiment.

FIG. 15 is a timing chart indicating an example of the frequency of update in recognition such that three-dimensional recognition according to the present embodiment and two-dimensional recognition combined with tracking of a feature point are performed in parallel.

FIG. 16 is an explanatory drawing of the display of a virtual object on the basis of two-dimensional recognition combined with tracking of a feature point according to the present embodiment.

FIG. 17 is an explanatory drawing of a state of a mismatch between a visual sense and a tactile sense.

FIG. 18 is an explanatory drawing illustrating an example of support for a tactile sense mismatch according to the present embodiment.

FIG. 19 illustrates a display example of a plurality of virtual objects according to the present embodiment.

FIG. 20 is a timing chart indicating the flow of a series of processing to explain display control that is performed using a plurality of recognition algorithms in the information processor according to the present embodiment.

### DESCRIPTION OF EMBODIMENTS

A preferred embodiment of the present disclosure will be described in detail with reference to the accompanying drawings. In the present specification and the drawings, constituent elements having substantially the same functional configuration will be denoted by the same reference numeral, and repeated descriptions thereof are omitted.

The description will be given in the following order.

1. Configuration example
1-1. Configuration example of information processor
1-2. Organization of problems
2. Technical features
2-1. Reduction in display delay time of virtual object
2-2. Operation processing
2-3. Support for safety
2-4. Support for tactile sense mismatch

### 3. Conclusion

### 1. CONFIGURATION EXAMPLE

### <1-1. Configuration Example of Information Processor>

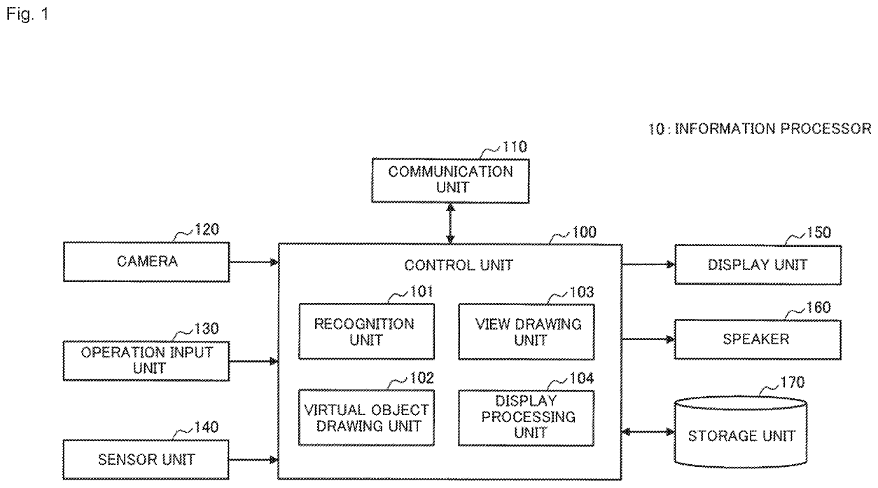

A basic configuration of an information processor 10 according to an embodiment of the present disclosure will be first described below. FIG. 1 is a block diagram illustrating an example of the basic configuration of the information processor 10 according to an embodiment of the present disclosure. As illustrated in FIG. 1, the information processor 10 includes a control unit 100, a communication unit 110, a camera 120, an operation input unit 130, a sensor unit 140, a display unit 150, a speaker 160, and a storage unit 170.

The information processor 10 according to the present embodiment mainly performs control to display a captured image of a real space on the display unit 150 and displays a virtual object superimposed according to the position of an object in the real space (hereinafter referred to as a real object) included in the captured image. The configurations of the information processor 10 will be described below.

### (1) Communication Unit 110

The communication unit 110 is connected to an external device and transmits and receives data to and from the external device via wire or radio communications. For example, the communication unit 110 is connected to a network to transmit and receive data to and from a server on the network. For example, the communication unit 110 may receive, from the server, data on a virtual object to be superimposed on a captured image of a real space or various kinds of data about superimposition. The communication unit 110 is connected to an external device or a network to perform communications via, for example, a wired/wireless LAN (Local Area Network), Wi-Fi (registered trademark), Bluetooth (registered trademark), or a mobile communication network (LTE (Long Term Evolution), 3G (third-generation mobile communication system), 4G (fourth-generation mobile communication system), and 5G (fifth-generation mobile communication system)).

### (2) Camera 120

The camera 120 is an example of an imaging unit having the function of capturing an image of a real space. An image of a real space captured by the camera 120 is displayed on the display unit 150. The captured image on the display unit 150 is displayed as a so-called through image corresponding to the view of a user of the information processor 10. The through image may be regarded as a captured image that is displayed in real time. Alternatively, the through image may be regarded as the latest one of images captured by the camera 120. An image of a real space captured by the camera 120 may be used for recognizing the real space.

In the present specification, a displayed image that corresponds to a user's view is also referred to as a view image. The camera 120 aimed at acquiring a view image is desirably oriented in the direction of the line of sight of the user who uses the information processor 10. It is assumed that the user views the display unit 150 when using the information processor 10. Thus, if the information processor 10 is implemented by, for example, an HMD that is mounted on the head of the user and is configured with the display unit 150 placed immediately in front of user's eyes when being mounted, the camera 120 is oriented in the same direction as the head of the user.

The camera 120 may be a single camera or a plurality of cameras. Alternatively, the camera 120 may be configured as a so-called stereo camera.

### (3) Operation Input Unit 130

The operation input unit 130 has the function of receiving a user operation. The operation input unit 130 outputs information about a received operation to the control unit 100. The operation input unit 130 may be implemented by an input device, e.g., a touch panel or a button.

### (4) Sensor Unit 140

The sensor unit 140 has the function of sensing a real space, for example, a position (user position) and a motion of the information processor 10 and the surrounding circumstances. The sensor unit 140 includes, for example, a position measuring unit, an acceleration sensor, an angular velocity sensor, and a terrestrial magnetism sensor. The sensor unit 140 may further include a camera for capturing an image used for recognizing a real space (a camera for recognition), the camera being different from the camera 120 for capturing a view image. In this case, the angle of view of the camera for recognition may include at least the angle of view of the camera 120 for capturing a view image. Furthermore, the sensor unit 140 may include a sensor for measuring a distance from an object existing in a real space. The sensor for measuring a distance may be a sensor for measurement based on a stereoscopic image captured by a stereo camera or an infrared sensor.

The position measuring unit has the function of calculating an absolute or relative position of the information processor 10. For example, the position measuring unit may detect a current position on the basis of a signal acquired from the outside. Specifically, a GNSS (Global Navigation Satellite System) that detects the current position of the information processor 10 by receiving, for example, radio waves from an artificial satellite. In addition to the GNSS, Wi-Fi (registered trademark), Bluetooth (registered trademark), transmission and reception to and from a cellular phone, a PHS, and a smartphone, or short-distance communications may be used for a method of detecting a position. The position measuring unit may estimate information indicating a relative change, on the basis of the detection result of an acceleration sensor or an angular velocity sensor or the like.

### (5) Display Unit 150

The display unit 150 is implemented by a so-called video see-through display. A video see-through display provides an image of a real space for the user by displaying, on the display, a moving image of the real space captured by an imaging device fixed relative to the display, that is, a through image in real time. In the case of a typical video see-through display, light in a real space is blocked by the casing of the video see-through display and does not directly reach user's eyes.

The display unit 150 may be switchable between a video see-through display and an optical see-through display. An optical see-through display is a display that can directly transmit light in a real space to user's eyes. An optical see-through display can be used in known modes including a half-mirror mode, a light-guide plate mode, and a retina direct-drawing mode. The outer surface of an optical see-through display has a configuration, for example, a dimming element that dynamically blocks light in a real space, enabling switching between the optical see-through display and a video see-through display.

Moreover, a video see-through display for implementing the display unit 150 may be a hand-held display for a smart phone or a mobile terminal for a wearable display. A mobile terminal may be connected wirelessly or via a cable to a computer separated from the mobile terminal. A video see-through display for implementing the display unit 150 can be provided in various mobile objects including an automobile. The function of controlling the display of a video see-through display may be performed by a standalone terminal or may be performed by a plurality of information processors via a wireless network or wired connection.

### (6) Speaker 160

The speaker 160 has the function of outputting sound. For example, the speaker 160 may be configured as headphones, earphones, or a bone conduction speaker.

### (7) Storage Unit 170

The storage unit 170 is implemented by ROM (Read Only Memory) in which programs used for the processing of the control unit 100 and arithmetic parameters or the like are stored, and RAM (Random Access Memory) in which optionally changed parameters or the like are temporarily stored.

### (8) Control Unit 100

The control unit 100 acts as an arithmetic processing unit and a controller and controls all operations in the information processor 10 in accordance with various programs. The control unit 100 is implemented by, for example, a CPU (Central Processing Unit) and electronic circuits such as a microprocessor. The control unit 100 may further include ROM (Read Only Memory) in which programs to be used and arithmetic parameters or the like are stored, and RAM (Random Access Memory) in which optionally changed parameters or the like are temporarily stored.

The control unit 100 according to the present embodiment also acts as a recognition unit 101, a virtual object drawing unit 102, a view drawing unit 103, and a display processing unit 104.

### (Recognition Unit 101)

The recognition unit 101 recognizes various kinds of data inputted to the control unit 100. Specifically, the recognition unit 101 recognizes a real space on the basis of a captured image of the real space. Alternatively, the recognition unit 101 may recognize its own position or orientation on the basis of sensing data or the like inputted from the sensor unit 140. When the control unit 100 superimposes a virtual object on a captured image of a real space such that the virtual object corresponds to a real object, the position and orientation of the real object or the position and orientation of the camera 120 (in other words, the information processor 10 including the camera 120 or a user wearing the information processor 10) are used.

### Recognition of Real Space

The recognition unit 101 recognizes a real space on the basis of a captured image of the real space. In the recognition of the real space, for example, an object (real object) in a captured image of the real space is recognized. The algorithm of object recognition is not particularly limited. For example, three-dimensional object recognition or a bone estimation algorithm may be used. Moreover, recognition may be performed by using a plurality of recognition algorithms at the same time, the recognition algorithms including an algorithm for recognizing humans and an algorithm for recognizing objects other than humans. The recognition of an object includes at least the position or orientation of the object. A captured image used for recognition may be an image captured by a camera that captures an image (through image) to be displayed on the display unit 150 or may be an image captured by a camera that is different from the camera and is provided for recognition. The recognition unit 101 may acquire depth data from the camera 120 or the sensor unit 140 and use the data for the recognition of a real space. The recognition unit 101 can acquire a distance from an object in a real space.

### Recognition of Own Position

The recognition unit 101 recognizes at least one of the position and orientation of the information processor 10 (more specifically, the camera 120) on the basis of the detection result of the sensor unit 140. The recognition by the recognition unit 101 may include processing performed by the position measuring unit or may be processing for acquiring, from the position measuring unit, information indicating its own position. For example, the recognition unit 101 recognizes its own position or orientation as information indicating a relative change, on the basis of the detection result of an acceleration sensor or an angular velocity sensor or the like. The information indicating its own position may include a moving velocity.

Alternatively, the recognition unit 101 may recognize the position of the information processor 10 (in other words, a user) by comparison with a space map generated in advance by a technique of SLAM (Simultaneous Localization and Mapping) or recognize a real-space positional relationship with a real object in a captured image. If the information processor 10 is an HMD to be mounted on a user's head, the recognition unit 101 can recognize the position, orientation, inclination, and a moving velocity or the like of the user's head as the recognition of its own position. In a specific example, the recognition unit 101 detects components in a yawing direction, a pitching direction, and a rolling direction as motions of the user's head, thereby recognizing a change of at least one of the position and orientation of the user's head.

### (Virtual Object Drawing Unit 102)

The virtual object drawing unit 102 draws a virtual object to be superimposed on a captured image (view image) in a real space, into a corresponding buffer. The buffer is at least a part of the storage area of a storage unit, e.g., flash memory or RAM for temporarily or permanently retaining various kinds of data. Moreover, the buffer is a so-called frame buffer for storing the display contents of a screen. At the completion of recognition by the recognition unit 101 on the basis of a captured image in a real space, the virtual object drawing unit 102 draws a virtual object at a proper position or with proper orientation relative to the position or orientation of a real object on the basis of the result of recognition (the position or orientation of the real object). Hereinafter, the buffer in which a virtual object to be superimposed on a view image is drawn will be also referred to as a virtual information buffer.

### (View Drawing Unit 103)

The view drawing unit 103 draws an image (view image) captured by the camera 120 in a real space, into a corresponding buffer. As an example, the buffer for drawing a view image and the buffer for drawing a virtual object are assumed to be separate storage areas. The separate storage areas may be different storage areas allocated in one storage unit or may be obtained by logically dividing the same storage area. Alternatively, different storage units may be allocated. Hereinafter, the buffer in which a captured image (view image) in a real space is drawn will be also referred to as a view information buffer.

### (Display Processing Unit 104)

The display processing unit 104 performs control (display control) to read information drawn in the buffer and output the information to the display unit 150. Specifically, for example, the display processing unit 104 performs control such that a virtual object read from the virtual information buffer is superimposed on a view image read from the view information buffer and is displayed on the display unit 150.

The configuration of the information processor 10 was specifically described above. The configuration of the information processor 10 according to the present disclosure is not limited to the example of FIG. 1. For example, the information processor 10 does not need to include all the configurations in FIG. 1.

A device for implementing the information processor 10 is, for example, a head-mounted display (HMD). The information processor 10 according to the present embodiment is implemented by, for example, a video see-through HMD. A video see-through HMD is configured to cover user's eyes when being mounted on the head or face of a user. A display unit, e.g., a display (the display unit 150 in the present embodiment) is held immediately in front of the user's eyes. Moreover, the video see-through HMD includes an imaging unit (the camera 120 in the present embodiment) for capturing an image of scenery around the user and displays, on the display unit, an image of scenery captured by the imaging unit ahead of the user. With this configuration, a user wearing a video see-through HMD may have difficulty in directly viewing scenery outside but can confirm the scenery through an image displayed on the display unit. If the information processor 10 is implemented by a video see-through HMD, the display unit 150 includes left and right screens fixed at positions corresponding to the left and right eyes of a user and displays a left-eye image and a right-eye image. The display unit provided for a video see-through HMD for implementing the information processor 10 according to the present embodiment may allow switching to an optical see-through display. The information processor 10 may be a terminal held with a user's hand, e.g., a smartphone, a cellular phone, or a tablet or a wearable device on a user's body.

The information processor 10 may be implemented by a plurality of devices. For example, the information processor 10 may be a system configured with a display device including at least the camera 120, the sensor unit 140, and the display unit 150 in FIG. 1 and a controller including at least the control unit 100. The display device and the controller are connected to each other via wire or radio communications and can transmit and receive data to and from each other. The display device and the controller may communicate with each other though, for example, Wi-Fi (registered trademark), a LAN (Local Area Network), or Bluetooth (registered trademark).

At least some of the functions of the control unit 100 in the information processor 10 may be implemented by a server provided on a network, a dedicated terminal disposed in the same space as the user, a smartphone, a tablet, or a PC.

### <1-2. Organization of Problems>

The following describes problems when a captured image in a real space is displayed in real time and a virtual object is superimposed thereon by using the video see-through display.

To obtain a view as if a virtual object is actually present in a real space, the virtual object is desirably displayed at the position of a real object. Also when the video see-through display is used, a real object is recognized on the basis of a captured image in a real space. At the completion of the recognition, a virtual object is drawn at a proper position or with proper orientation according to the position or orientation of the real object on the basis of the result of recognition.

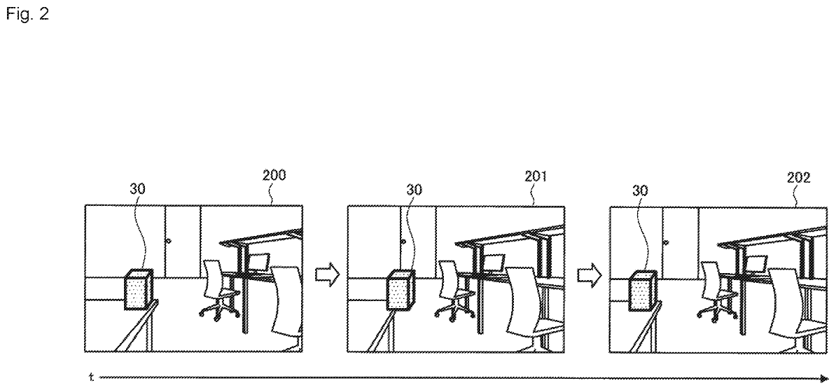

The drawing of a virtual object requires the recognition of a real space as a preceding step and thus may be delayed from the drawing of a captured image in a real space. For example, if the user moves to change the view, processing for drawing a virtual object may stay behind processing for drawing a captured image in a real space. FIG. 2 is an explanatory drawing illustrating unnaturalness caused by a display delay of a virtual object. A displayed image in FIG. 2 is an example of an image displayed on the display unit 150. The displayed image includes a captured image (view image) in a real space and a virtual object 30. For example, if the user turns right (the camera 120 turns right), an image captured by the camera 120 is displayed in real time on the display unit 150 (for example, about 15 milliseconds from imaging to display) as illustrated in a display image 200 and a display image 201 in FIG. 2, so that the view changes. If the view is covered with the display unit 150 and scenery in a real space does not directly come into sight, the user hardly notices a displacement (display delay) between a real view and a view image displayed on the camera 120, which does not interfere with naturalness. In contrast, a display delay of the virtual object 30 relative to the view image tends to be noticeable even if the displacement is relatively small, leading to unnaturalness. Specifically, as indicated in the display image 201 of FIG. 2, the latest (current) image is displayed as a view image. At this point, the recognition of the latest (current) view image is not completed, so that the display position of the virtual object 30 is displaced from a desk (real object), leading to unnaturalness. Thereafter, at the completion of recognition and drawing based on the recognition, the display position of the virtual object 30 is updated to a proper position corresponding to the position of the desk as indicated in a display image 202.

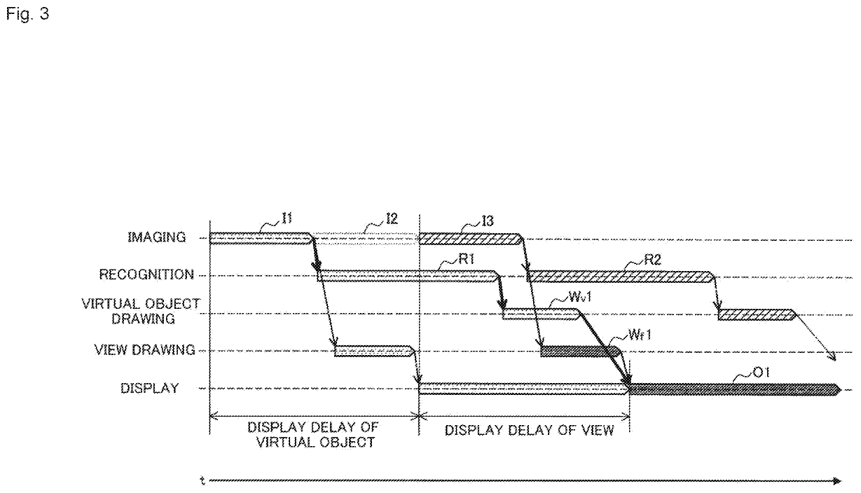

Referring to FIG. 3, the principle of a display delay of the virtual object 30 will be specifically described below. FIG. 3 is a timing chart indicating the flow of a series of processing to explain a display delay of the virtual object 30.

As indicated in FIG. 3, a series for displaying a virtual object superimposed on a real object includes “imaging” of a real space, “recognition” of a real object by analyzing a captured image, “drawing (virtual object drawing)” of a virtual object to be superimposed, “drawing (view drawing)” of a captured image, and “display (output)” of the drawn virtual object and the captured image. A captured image is drawn when being acquired. A virtual object is drawn after the completion of the recognition of the captured image. In the recognition, processing requiring a processing time (an example of a load of recognition), for example, three-dimensional object recognition can be performed. The view drawing, the recognition, and the virtual object drawing are performed in parallel, but the completion of the virtual object drawing is delayed from the completion of a captured image.

In the example of FIG. 3, a captured image used as a view image and a captured image used for recognition are both indicated to be obtained from a single step of “imaging” (imaging unit). “Imaging” (imaging unit) may be provided in multiple steps. Specifically, “imaging” (imaging unit) for acquiring a captured image used as a view image and “imaging” (imaging unit) for acquiring a captured image used for recognition may be provided. The processing of display may be typically updated at 90 Hz. A time for recognition may be assumed to be, for example, about 12 ms to 13 ms depending upon the hardware performance, the kind of recognition algorithm, and a target of recognition.

As indicated in FIG. 3, when imaging I1 is performed by the camera 120, the recognition unit 101 analyzes a captured image (1) acquired by the imaging I1 and performs recognition R1 for recognizing a real object. The virtual object drawing unit 102 then performs drawing Wᵥ1 of a virtual object on the basis of the recognition result of the recognition R1. Since the camera 120 continuously performs imaging, a captured image (3) acquired by imaging I3 is the latest view image at the completion of the drawing Wᵥ1 by the virtual object drawing unit 102, and then the view drawing unit 103 performs drawing W_{f}1 of the captured image (3). Subsequently, the display processing unit 104 performs display processing O1 for displaying, on the display unit 150, the virtual object drawn by the drawing Wᵥ1 on the basis of the recognition result of the captured image (1) and the latest captured image (3) that is drawn in the drawing W_{f}1. Specifically, when the latest captured image (3) drawn in the drawing W_{f}1 is displayed, recognition R2 of the latest captured image (3) is not completed and the virtual object drawn by the drawing Wᵥ1 based on the recognition R1 is stored in a buffer for reading, so that the virtual object drawn by the drawing Wᵥ1 is read and is displayed while being superimposed.

In the display processing O1, a display delay of a view and a display delay of the virtual object may occur as indicated in FIG. 3. The display delay of a view is a displacement between real outside scenery and a displayed view image. Specifically, for example, a time from the imaging I3 to the display (output) of the captured image (3) acquired by the imaging I3. The display delay of the virtual object is a displacement between a view image and the virtual object. Specifically, a time between a time when the imaging I3 is performed to acquire the view image (captured image (3)) and a time when the imaging I1 is performed to acquire the captured image (1) based on the recognition result (recognition R1) that is referenced in the drawing of the virtual object. In other words, the display position or orientation of the virtual object outputted in the display processing O1 is based on the captured image (1) acquired by the imaging I1, and the view image is the captured image (3) acquired by the imaging 3. If the view changes before the drawn virtual object is displayed, a displacement may occur in the relative positional relationship between the position of the real object of the view image and the position of superimposition of the drawn virtual object.

As described above, if the view is covered with the display unit 150 and scenery in a real space does not directly come into sight, a displacement between a real view (outside scenery) and a view image displayed on the camera 120 is hardly noticed in the display delay of the view, which does not interfere with naturalness. In contrast, as described with reference to FIG. 2, even a small display delay of the virtual object tends to be noticeable, leading to unnaturalness. In the example of FIG. 3, the virtual object to be superimposed on the view image has two frames of display delay (two imaging processes).

Thus, the present disclosure proposes the information processor 10 that can reduce a displacement of the relative positional relationship between a real object and a virtual object (that is, a display delay when the virtual object is superimposed on a view) in a video see-through display and perform more suitable display control.

### 2. TECHNICAL FEATURES

The technical features of the information processor 10 according to the present embodiment will be described below.

### <2-1. Reduction in Display Delay Time of Virtual Object>

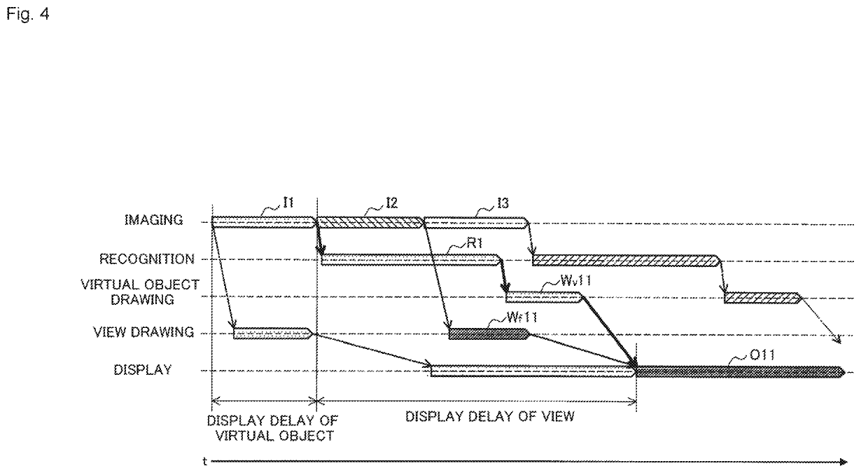

FIG. 4 is a timing chart indicating the flow of a series of processing to explain display control according to the present embodiment. In the present embodiment, as indicated in FIG. 4, a view image displayed (outputted) in display processing O11 is not the latest (current) captured image (a captured image acquired by the imaging I3) but a past captured image (for example, a captured image acquired by the imaging I2). Specifically, the display processing unit 104 performs control to display a virtual object superimposed on a view image, the virtual object being drawn by the drawing Wᵥ1 on the basis of the recognition result of the recognition R1 in which the captured image (1) acquired by the imaging I1 is analyzed and recognized, the view image being drawn by the drawing W_{f}1 on the basis of the captured image (2) acquired by the imaging I2. In this case, the display of the virtual object is delayed by one frame relative to the view image, so that the display delay is shorter than that in the example of FIG. 3. In contrast, the display delay time of the view is longer than that in the example of FIG. 3. However, “the display delay of the view” is hardly noticed by a user, so that even if “the display delay of the view” is extended, unnaturalness is reduced by preferentially reducing “the display delay of the virtual object superimposed on the view image,” enabling more suitable display control. Moreover, image deformation or prediction is not performed, thereby reducing the artificiality of a position and orientation when a virtual object is superimposed.

In the example of FIG. 4, imaging is continuously performed after the imaging I3. The subsequent imaging is omitted. Moreover, in display processing immediately before the display processing O11, a captured image that is acquired by imaging performed immediately before the imaging I1 is used as a view image. The captured image is omitted. Furthermore, display processing in the past is also omitted. In the present embodiment, the imaging speed of a view and the frequency of display update can be maintained. The display processing unit 104 uses, as a view image to be displayed, a captured image prior to a current (latest) captured image while keeping the frequency of display update, thereby reducing the display delay of a virtual object to be superimposed on the view image. In the example of FIG. 4, a captured image of an immediately preceding frame is selected as a view image to be displayed. The selection is merely exemplary. A captured image in the second frame prior to the current frame may be selected instead, and the frame of an image to be selected is not particularly limited.

### <2-2. Operation Processing>

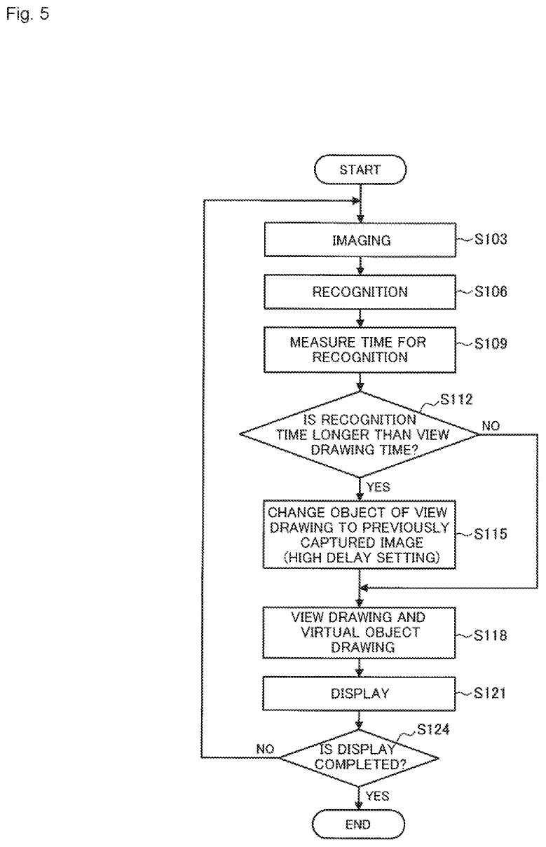

FIG. 5 is a flowchart indicating an example of a flow of display control performed by the information processor according to the present embodiment. As indicated in FIG. 5, first, the camera 120 of the information processor 10 performs imaging to capture an image of a real space (step S103). If an additional camera is provided for recognition, the camera for recognition also performs imaging to capture an image of the real space in parallel with the camera 120.

The recognition unit 101 of the information processor 10 then analyzes a captured image of the real space and recognizes a real object (step S106). The recognition is performed on the basis of the latest captured image with respect to the start time of the recognition.

Subsequently, the control unit 100 measures a time for the recognition (step S109). In the present embodiment, “time” required for recognition is described as an example of a load of recognition. A time required for recognition means a time from the start of recognition of a captured image in a real space by the virtual object drawing unit 102 to the completion of the recognition. The time required for recognition may vary depending on the feature of a recognition algorithm used for analyzing a captured image and the number of used algorithms. Furthermore, the time required for recognition also varies depending on the target and level of recognition. For example, in the case of an algorithm with a high processing load, e.g., three-dimensional object recognition or bone estimation, a longer time is necessary as compared with two-dimensional object recognition or the like. Moreover, a plurality of recognition algorithms may be used, the recognition algorithms including an algorithm for recognizing a change (difference) from a past captured image. Alternatively, a plurality of recognition algorithms may be used for different objects to be recognized. If a plurality of recognition algorithms are used, a recognition time to be measured is a time until the completion of recognition of all the algorithms.

Subsequently, the control unit 100 determines whether the recognition time is longer than a view drawing time (step S112). The view drawing time means a time from the start of drawing of a view image in the buffer by the virtual object drawing unit 102 to the completion of the drawing. The recognition can be processed in parallel with the view drawing. The control unit 100 may determine whether the recognition is completed after the view drawing time. In an example of a first load of the present disclosure, a recognition time is equal to or shorter than a view drawing time. In an example of a second load greater than the first load of the present disclosure, a recognition time is longer than a view drawing time. In other words, the first load corresponds to the case where a time required for recognition is equal to or shorter than a time for drawing a captured image. The second load corresponds to the case where a time required for recognition is longer than a time for drawing a captured image.

Subsequently, if a recognition time is longer than a view drawing time (that is, if a recognition time corresponds to the second load) (step S112/Yes), the view drawing unit 103 changes an object of view drawing to a previously captured image (step S115). In other words, the view drawing unit 103 selects a past captured image instead of the current (latest) captured image (that is, a through image) as an object of view drawing. Which one of past captured images is to be selected is not particularly limited. For example, the selected image may be a captured image that is acquired at the same timing as a captured image that is used in recognition for drawing a virtual object, or a more newly captured image. Moreover, the imaging time of the past captured image may be within a tolerance from the current time. The tolerance is desirably set at a level where the user does not feel unnaturalness about a difference (the display delay of a view) between real outside scenery and a view image. “A level where the user does not feel unnaturalness” may be set at a predetermined value (the upper limit of the display delay of a view) or may be flexibly changed depending on the situation. The situation indicates a motion range of the user and a change around the user. As the display delay of a view is extended, the display delay of a virtual object can be shortened to reduce unnaturalness. It is desirable to suppress a difference between real outside scenery and a view image from the user in view of safety.

As described above, in a typical video see-through display, the current (latest) captured image is displayed as real-time as possible. In the present embodiment, a displacement of display between a virtual object and a view image is suppressed by delaying view display. In the present specification, first processing for drawing the current (latest) captured image (through image) as a view image is processing with a small delay in view display and is referred to as “low-delay processing.” Furthermore, according to the present embodiment, second processing for drawing a past captured image as a view image and delaying view display is processing with a larger delay in view display than “low-delay processing” and is referred to as “high-delay processing” in the present specification.

In the present embodiment, a time (a time required for recognition) is described as an example of a load of recognition. The present disclosure is not limited thereto. For example, a load of recognition may be based on the kind of recognition algorithm or a frame rate.

Subsequently, the control unit 100 causes the view drawing unit 103 to draw the view image into the view information buffer and causes the virtual object drawing unit 102 to draw the virtual object into the virtual information buffer (step S118). These drawing processes can be performed in parallel.

Subsequently, if a recognition time is equal to or shorter than a view drawing time (that is, if a recognition time corresponds to the first load) (step S112/No), the view drawing unit 103 does not change an object of view drawing. In other words, the view drawing unit 103 draws a captured image at the latest imaging time (that is, a through image) in the view information buffer as usual.

The control unit 100 then causes the display processing unit 104 to read information drawn in each of the buffers and display the information on the display unit 150 (step S121). Specifically, the display processing unit 104 performs control to display the virtual object superimposed on the view image.

The processing of steps S103 to S121 is repeated until the completion of the display control of the display unit 150 (step S124).

The flow of display control according to the present embodiment was specifically described above. The order of processing according to the present disclosure is not limited to the flow of FIG. 5. For example, the imaging in step S103 and the recognition in step S106 may be performed in parallel. At the completion of the recognition, the recognition unit 101 acquires the latest captured image as a subsequent object of recognition and starts recognition.

### <2-3. Support for Safety>

The information processor 10 according to the present embodiment performs, optionally depending on the situation, switching from the high-delay processing (second processing) for displaying a past captured image as a view image to the low-delay processing (first processing) for displaying the current (latest) captured image (through image) as a view image, thereby supporting safety.

For example, when the user of the information processor 10 is moving at a specified speed or higher, the information processor 10 performs control to switch the high-delay processing to the low-delay processing in view of safety. Upon switching (switching from a display state of a past captured image to a display state of the current captured image), switching can be achieved with reduced unnaturalness and artificiality by using measures such as the use of a view image deformed over a predetermined number of frames according to the speed (gradually bringing the view image to the current/past captured image). The details will be described later.

Upon switching to the low-delay processing, the information processor 10 may shorten the recognition as much as possible by changing the kind of recognition algorithm to be used or increasing a frame rate. This can reduce the display delay of a virtual object during the low-delay processing. The details will be described later.

When a mobile object is present near the user, the information processor 10 may perform control to switch the high-delay processing to the low-delay processing. If the user is likely to collide with a real object, the information processor 10 may stop the display of a superimposed virtual object (a view image is displayed by the low-delay processing).

The support for each item of safety will be specifically described below.

(1) Switching control between high-delay processing and low-delay processing First, switching control between the high-delay processing and the low-delay processing according to the speed of the user will be described below. The speed of the user means a speed of the user who wears or holds the information processor 10 on the head or the like. The speed may be also referred to as the speed of the information processor 10 (at least the camera 120). In addition to the switching control between the high-delay processing and the low-delay processing, a threshold value is set for stopping the superimposition of a virtual object. The threshold value for stopping the superimposition of a virtual object is set by, for example, a distance. Such a threshold value is also referred to as a superimposition stop line.

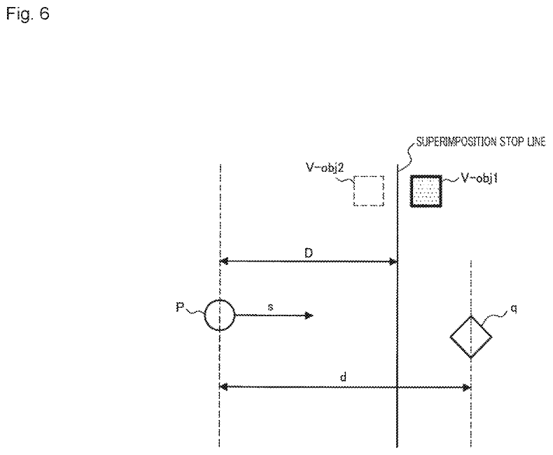

FIG. 6 is an explanatory drawing of a superimposition stop line and a judgement criterion element for switching control. As illustrated in FIG. 6, the information processor 10 acquires an own position P, an own speed s, and a distance d from a moving object q on the basis of sensing by the sensor unit 140 and recognition by the recognition unit 101. The moving object q is assumed to be an object present in a real space and an object being relocated (moved). For example, the object is assumed to be a human, a bicycle, an automobile, a self-propelled robot, or a drone.

The information processor 10 sets a superimposition stop line (distance D) for stopping the superimposed display of a virtual object according to, for example, the own speed s. The display position of a virtual object obj may include depth information. The information processor 10 performs non-display control when the display position of the virtual object obj is closer than the superimposition stop line (near the own position P), and performs display control when the display position of the virtual object obj is more remote than the superimposition stop line. Thus, in the example of FIG. 6, a virtual object V-obj1 located more remote than the superimposition stop line is displayed, whereas a virtual object V-obj2 located closer than the superimposition stop line is hidden.

Moreover, the information processor 10 optionally performs control to switch between the high-delay processing and the low-delay processing according to the own speed s and the distance d from the moving object q.

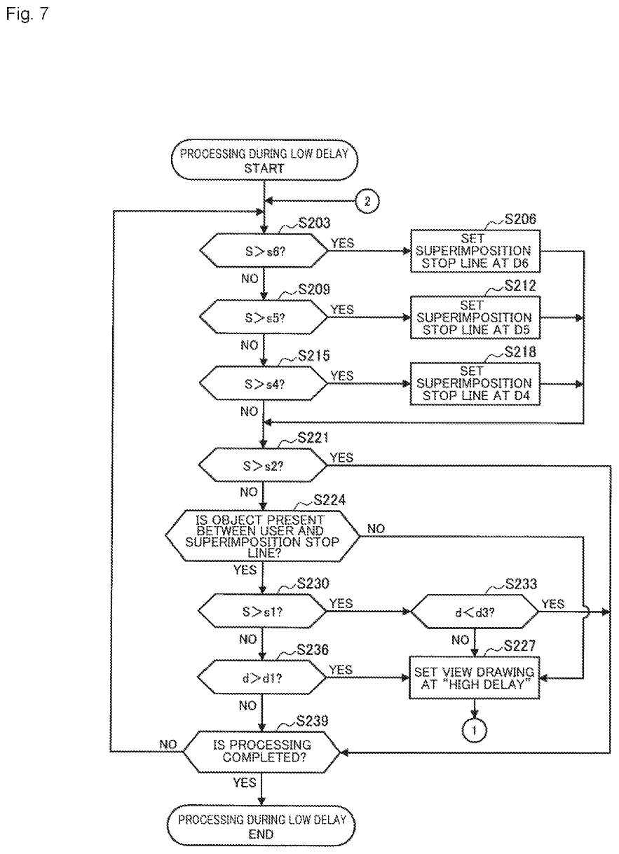

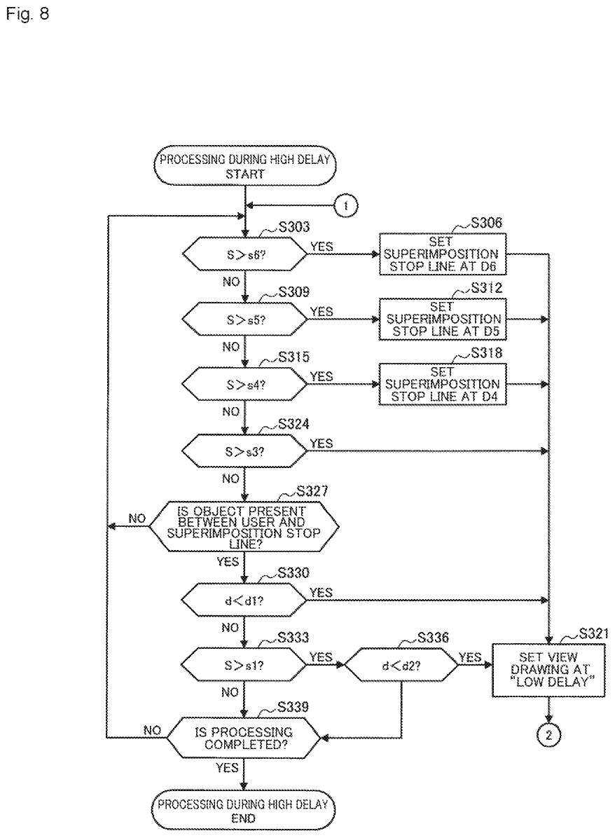

Referring to FIGS. 7 and 8, an example of a flow of switching between low delay/high delay will be described below. Table 1 indicates threshold values specified for the own speed s used in FIGS. 7 and 8.

TABLE 1
Low← →High
s1 > s2 > s3 > s4 > s5 > s6

Table 2 indicates threshold values specified for the own position P and the distance d from the moving object q, the own position P and distance d being used in FIGS. 7 and 8. In Table 2, “Near” indicates a short distance from the own position P while “Remote” indicates a long distance from the own position P.

TABLE 2
Near ← →Remote
d1 > d2 > d3 >

Table 3 indicates threshold values (the distance D from the own position P) specified for the superimposition stop line used in FIGS. 7 and 8. In Table 3, “Near” indicates a short distance from the own position P while “Remote” indicates a long distance from the own position P. The relationship of d3<D4 is established for a distance value.

TABLE 3
Near← →Remote
D4 > D5 > D6 >

Switching to High Delay During Low Delay

FIG. 7 is a flowchart indicating an example of a flow of switching during low delay according to the present embodiment. During the low delay, control is performed with a small delay in view display. In other words, control is performed to draw the current (latest) captured image as a view image and display the image on the display unit 150. FIG. 7 describes switching to high delay in this case.

As indicated in FIG. 7, first, if the own speed s is larger (higher) than s6 (step S203/Yes), the control unit 100 sets the superimposition stop line at D6 (step S206). Subsequently, if the own speed s is larger (higher) than s5 (step S209/Yes), the control unit 100 sets the superimposition stop line at D5 (step S212).

Thereafter, if the own speeds is larger (higher) than s4 (step S215/Yes), the control unit 100 sets the superimposition stop line at D4 (step S218).

The display processing unit 104 performs processing such that a virtual object located closer than (near the user) the set superimposition stop line is displayed without being superimposed. Processing for switching from low delay to high delay according to the own speed s and the distance d from the moving object q will be described below.

If the own speed s is smaller (lower) than s2 (step S221/No), the control unit 100 performs switching to high-delay processing (high-delay setting) according to the conditions.

Specifically, if the moving object q is not present between the user and the superimposition stop line (step S224/No), the control unit 100 sets view drawing at high delay (step S227). In other words, the control unit 100 sets view drawing at a mode for performing delay control on view display according to the present embodiment, in which a past view image is drawn in the buffer. In this case, the following condition is set:

The own speed s<s2 Condition 1

(Note that the moving object q is not present between the user and the superimposition stop line)

If the moving object q is present between the user and the superimposition stop line (step S224/Yes), the control unit 100 determines whether the own speed s is larger than (higher than) s1 (step S230).

If the own speeds is larger (higher) than s1 (step S230/Yes), the control unit 100 further determines whether the distance d from the moving object q is larger (more remote) than d3 (step S233).

If the distance d from the moving object q is larger (more remote) than d3 (step S233/Yes), the control unit 100 sets view drawing at high delay (step S227). In this case, the following condition is set:

s1<the own speed s<s2 and the distance d>d3 Condition 2

In step S230, if it is determined that the own speed s is smaller (lower) than s1 (step S230/No), the control unit 100 further determines whether the distance d from the moving object q is larger (more remote) than d1 (step S236).

If the distance d from the moving object q is larger (more remote) than d1 (step S236/Yes), the control unit 100 sets view drawing at high delay (step S227). In this case, the following condition is set:

The own speed s<s1 and the distance d>d1 Condition 3

The processing of steps S203 to S236 is repeated until the completion of the low-delay processing (step S239).

The description has so far explained switching to high delay. If the foregoing conditions are not met (step S221/Yes, step S233/No, step S236/No), the control unit 100 keeps a low-delay setting without switching to high delay.

### Switching to Pulling Delay During High Delay

FIG. 8 is a flowchart indicating an example of a flow of switching during high delay according to the present embodiment. During the high delay, control is performed with a large delay in view display. In other words, control is performed to draw a past captured image as a view image and display the image on the display unit 150. FIG. 8 describes switching to low delay in this case.

As indicated in FIG. 8, first, if the own speed s is larger (higher) than s6 (step S303/Yes), the control unit 100 sets the superimposition stop line at D6 (step S306).

Subsequently, if the own speed s is larger (higher) than s5 (step S309/Yes), the control unit 100 sets the superimposition stop line at D5 (step S312).

If the own speeds is larger (higher) than s4 (step S315/Yes), the control unit 100 sets the superimposition stop line at D4 (step S318).

The display processing unit 104 performs processing such that a virtual object located closer than (near the user) the set superimposition stop line is displayed without being superimposed.

In all of the cases where the own speed s is larger (higher) than s6 (step S303/Yes), the own speed s is larger (higher) than s5 (step S309/Yes), and the own speed s is larger (higher) than s4 (step S315/Yes), the control unit 100 performs switching to low-delay processing (low-delay setting) (step S321). Also in the case where the own speed s is larger (higher) than s3 (step S324/Yes), the control unit 100 performs switching to low-delay processing (low-delay setting) (step S321). In this case, the following condition is set:

The own speed s>s3 Condition 1

As described above, if the speed of the user exceeds a threshold value, high-delay processing is switched to low-delay processing as support for safety.

If the own speed s is smaller (lower) than s3 (step S324/No), the control unit 100 performs switching to low-delay processing (low-delay setting) according to the conditions.

Specifically, the control unit 100 determines whether the moving object q is present between the user and the superimposition stop line (step S327).

If the moving object q is present between the user and the superimposition stop line (step S327/Yes) and the distance d from the moving object q is smaller (closer) than d1 (step S330/Yes), the control unit 100 performs switching to low-delay processing (low-delay setting) (step S321). In this case, the following condition is set:

The own speed s<s3 and the distance d<d1 Condition 2

As described above, if the speed of the user does not exceed a threshold value but the moving object is quite close to the user, high-delay processing is switched to low-delay processing as support for safety.

If the distance d is larger (more remote) than d1 in step S330 (step S330/No), the control unit 100 determines whether the own speed s is larger (higher) than s1 (step S333).

If the own speed s is larger (higher) than s1 (step S333/Yes) and the distance d from the moving object q is smaller (closer) than d2 (step S336/Yes), the control unit 100 performs switching to low-delay processing (low-delay setting) (step S321). In this case, the following condition is set:

s1<the own speed s<s3 and the distance d<d2 Condition 3

As described above, if the speed of the user does not exceed a threshold value but the moving object is close to the user, high-delay processing is switched to low-delay processing as support for safety.

The processing of steps S303 to S336 is repeated until the completion of the high-delay processing (step S339).

The description has so far explained switching to low delay. If the foregoing conditions are not met (step S327/No, step S333/No, step S336/No), the control unit 100 keeps a high-delay setting without switching to low delay.

As indicated in step S221 of FIG. 7 and step S324 of FIG. 8, the view drawing unit 103 switches to low delay during high-delay processing when the own speed s>s3 is satisfied (that is, s3 is used as a stop threshold value of high delay) and the view drawing unit 103 switches to high delay during low-delay processing when the own speed s<s2 is satisfied (that is, s2 is used as a start threshold value of high delay), thereby suppressing repetitions of start/stop of high delay in a short time.

### (2) Measures Upon Switching

The following describes measures for reducing unnaturalness and artificiality upon switching between the high-delay processing and the low-delay processing.

Upon switching between low-delay processing and high-delay processing, the control unit 100 enables switching with reduced unnaturalness and artificiality by using measures such as the use of a view image deformed over a predetermined number of frames (gradually bringing the view image to the current/past captured image). For example, processing for bringing the view image to the current/past captured image can be implemented by gradually deforming the image on the basis of the latest own position during the drawing of the captured image (view image). Alternatively, quick switching can be performed in view of safety (without the processing for gradually bringing the view image to the current/past captured image).

Which one of the switching methods is to be used can be selected according to, for example, the own speed s.

Switching while Gradually Bringing View Image to Current/Past Captured Image

The view drawing unit 103 deforms a captured image on the basis of the own position of the information processor 10 at a predetermined time after the imaging time of the captured image to be drawn, thereby gradually bringing the image to the current/past captured image. In this case, the image can be deformed by using, for example, a margin of a view image included in an image captured by the camera 120. In other words, it is assumed that an image captured by the camera 120 is acquired with a larger angle of view than a view image. The view drawing unit 103 enables image deformation by performing drawing after moving the range of a view image, which is normally located at the center in the captured image, in a predetermined direction according to a change (movement) of the own position from the imaging time.

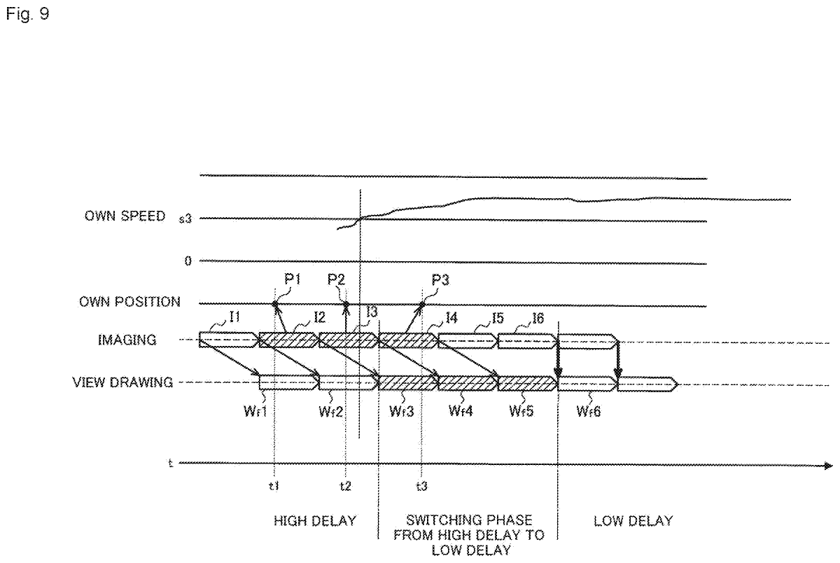

FIG. 9 is a timing chart for explaining the switching of a view image over a predetermined number of frames upon switching from high delay to low delay according to the present embodiment. In the example of FIG. 9, high-delay processing is switched to low-delay processing when the own speed s exceeds s3 during the high-delay processing.

As indicated in FIG. 9, in view drawing W_{f}1 and W_{f}2 during high-delay processing, the view drawing unit 103 draws, for example, a captured image of an immediately preceding frame. In this case, if the own speed s exceeds s3, the view drawing unit 103 draws a captured image after image deformation based on an own position P from view drawing W_{f}3 that is started after the own speed s exceeds s3. In the example of FIG. 9, the image is deformed in the view drawing W_{f}3, W_{f}4, and W_{f}5 (that is, over three frames). The number of frames is not particularly limited.

More specifically, for example, the view drawing unit 103 in the view drawing W_{f}3 deforms and draws a captured image, which is acquired by the imaging I2, on the basis of an own position P1 at a time t1. Subsequently, the view drawing unit 103 in the view drawing W_{f}4 deforms and draws a captured image, which is acquired by the imaging I3, on the basis of an own position P2 at a time t2. Thereafter, the view drawing unit 103 in the view drawing W_{f}5 deforms and draws a captured image, which is acquired by the imaging I3, on the basis of an own position P3 at a time t3. The view drawing unit 103 then draws a captured image, which is acquired by the imaging I6, in view drawing W_{f}6 (low-delay processing).

Specifically, since a captured image delayed by one frame is drawn before switching (during high-delay processing), a captured image to be used is first deformed at the own position P1 at the time t1 delayed by three quarters of a frame, at the time t2 delayed by two quarters of the frame, and at the time t3 delayed by one quarter of the frame. Such a gradual reduction in delay can reduce unnaturalness and artificiality upon switching to low delay. The time intervals at t1 to t3 are merely exemplary and are not necessarily regular intervals.

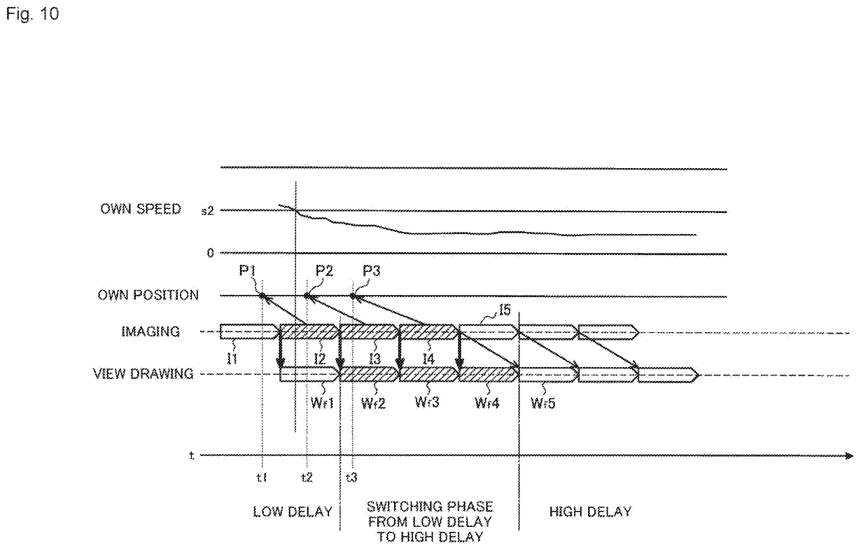

FIG. 10 is a timing chart for explaining the switching of a view image over a predetermined number of frames upon switching from low delay to high delay according to the present embodiment. In the example of FIG. 10, low-delay processing is switched to high-delay processing when the own speed s falls below s2 during the low-delay processing.

As indicated in FIG. 10, in view drawing W_{f}1 during low-delay processing, the view drawing unit 103 draws the current (latest) captured image (a captured image acquired by the imaging I1). In this case, if the own speed s falls below s2, the view drawing unit 103 draws a captured image after image deformation based on the own position P from the view drawing W_{f}2 that is started after the own speed s falls below s2. In the example of FIG. 10, the image is deformed in the view drawing W_{f}2, W_{f}3, and W_{f}4 (that is, over three frames). The number of frames is not particularly limited.

More specifically, for example, the view drawing unit 103 in the view drawing W_{f}2 deforms and draws a captured image, which is acquired by the imaging I2, on the basis of the own position P1 at the time t1. Subsequently, the view drawing unit 103 in the view drawing W_{f}3 deforms and draws a captured image, which is acquired by the imaging I3, on the basis of the own position P2 at the time t2. Thereafter, the view drawing unit 103 in the view drawing W_{f}4 deforms and draws a captured image, which is acquired by the imaging I4, on the basis of the own position P3 at the time t3. The view drawing unit 103 then draws a captured image, which is acquired by the imaging I4, (without deforming the image) in the view drawing W_{f}5 (high-delay processing).

Specifically, since the latest captured image is drawn before switching (during low-delay processing), a captured image to be used is first deformed at the own position P1 at the time t1 delayed by one quarter of a frame, at the time t2 delayed by two quarters of the frame, and at the time t3 delayed by three quarters of the frame. Such a gradual increase in delay can reduce unnaturalness and artificiality upon switching to high delay. The time intervals at t1 to t3 are merely exemplary and are not necessarily regular intervals.

### Quick Switching

Quick switching performed in view of safety (without the processing for gradually bringing the view image to the current/past captured image) will be described below.

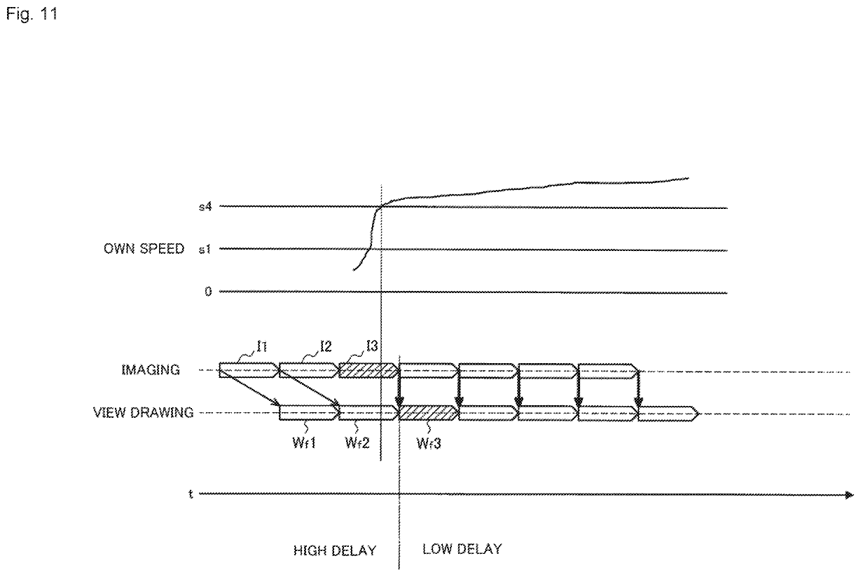

FIG. 11 is a timing chart for explaining quick switching of a view image upon switching from high delay to low delay according to the present embodiment. In the example of FIG. 11, high-delay processing is quickly switched to low-delay processing when the own speed s exceeds s4 during the high-delay processing.

As indicated in FIG. 11, in the view drawing W_{f}1 and W_{f}2 during high-delay processing, the view drawing unit 103 draws a captured image of an immediately preceding frame. In this case, if the own speed s exceeds s4, the view drawing unit 103 draws the current (latest) captured image (a captured image acquired by the imaging I3) in the view drawing W_{f}3 that is started after the own speed s exceeds s4. Thus, by switching to the current captured image from the view drawing immediately after the own speed s exceeds s4, quick switching supporting safety can be achieved.

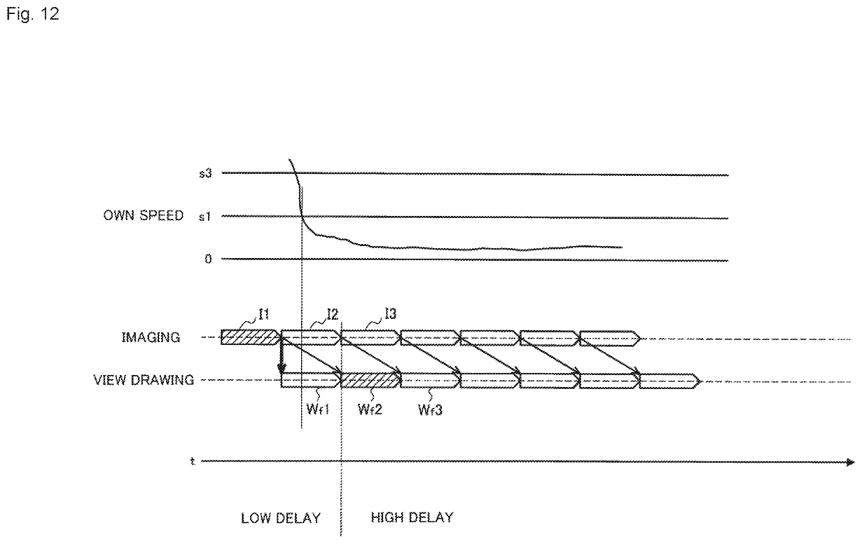

FIG. 12 is a timing chart for explaining quick switching of a view image upon switching from low delay to high delay according to the present embodiment. In the example of FIG. 12, low-delay processing is quickly switched to high-delay processing when the own speed s falls below s1 during the low-delay processing.

As indicated in FIG. 12, in the view drawing W_{f}1 during low-delay processing, the view drawing unit 103 draws the current (latest) captured image (a captured image acquired by the imaging I1). In this case, if the own speeds falls below s1, the view drawing unit 103 draws a captured image of an immediately preceding frame (a captured image acquired by the imaging I1) in the view drawing W_{f}2 that is started after the own speed s falls below s1. Thus, by switching to a past captured image from the view drawing immediately after the own speed s falls below s1, quick switching supporting safety can be achieved.

### (3) Change of Recognition Algorithm During Low-Delay Processing

Various kinds of recognition algorithms are used in recognition. For example, three-dimensional object recognition and a bone estimation algorithm can recognize positions and orientation but result in relatively long processing times. Two-dimensional object recognition tends to have shorter processing times than three-dimensional object recognition but tends to result in insufficient real-space recognition for properly superimposing a virtual object as compared with three-dimensional object recognition and a bone estimation algorithm. Instead of object recognition, an algorithm for tracking a change of a feature point from a previous frame and the direction of the change is available. Such an algorithm may be used in combination with two-dimensional object recognition or three-dimensional object recognition or the like.

In this case, when a view image is switched to low-delay processing, the control unit 100 shortens a recognition time by changing an algorithm used for recognition, thereby minimizing the display delay of a virtual object (a displacement from the display of a real object).

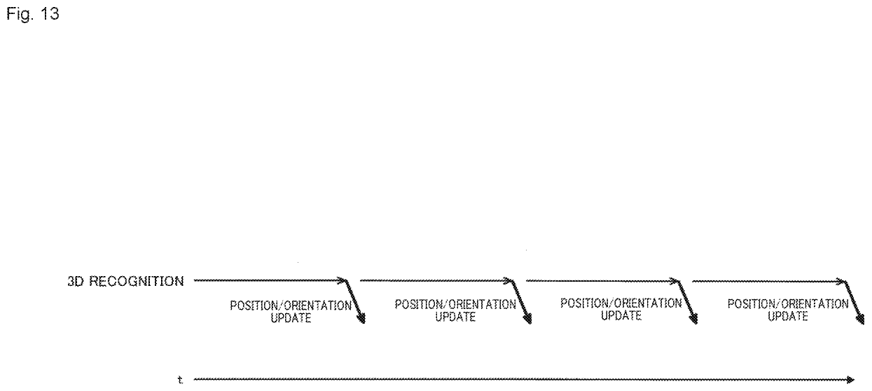

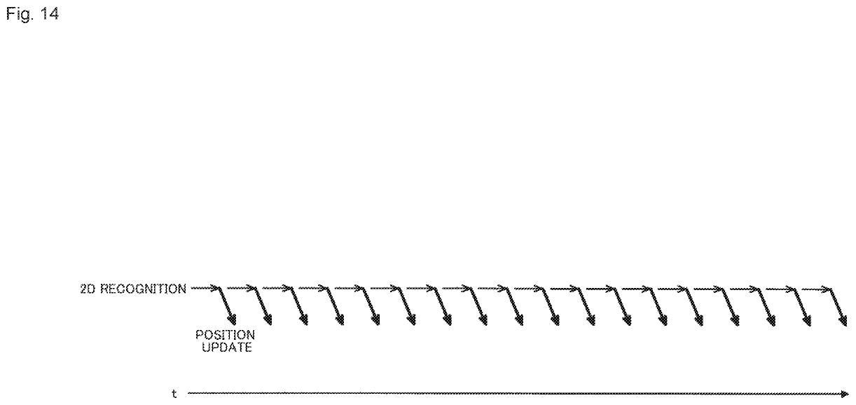

FIGS. 13 and 14 indicate examples of the frequency of update in recognition when different kinds of recognition algorithms are used. FIG. 13 is a timing chart indicating an example of the frequency of update in recognition when a three-dimensional object recognition algorithm is used. FIG. 14 is a timing chart indicating an example of the frequency of update in recognition when a two-dimensional object recognition algorithm is used. In a comparison between FIG. 13 and FIG. 14, recognition (recognition of a position and orientation) using the three-dimensional object recognition algorithm is more time-consuming than recognition (recognition of a position) using the two-dimensional object recognition algorithm, so that the update frequency of the update frequency is low. Thus, when a view image is switched to low-delay processing, the recognition unit 101 can shorten the recognition by changing the three-dimensional recognition algorithm to the two-dimensional recognition algorithm.

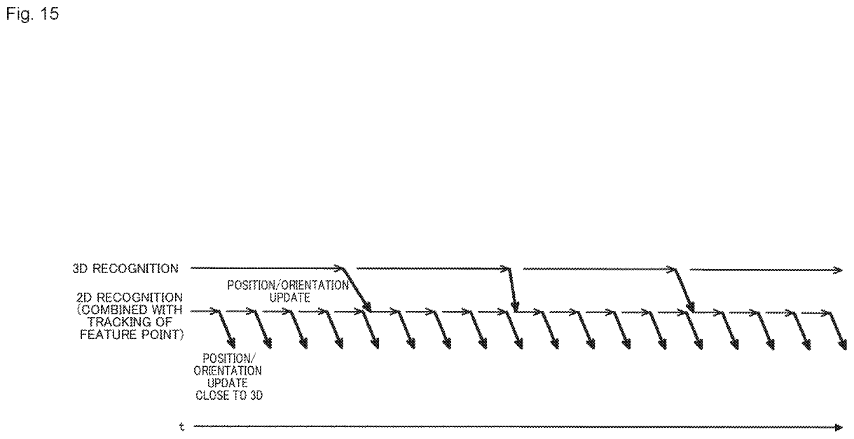

Alternatively, as indicated in FIG. 15, three-dimensional recognition and two-dimensional recognition combined with tracking of a feature point may be performed in parallel. If the result of three-dimensional recognition is obtained in two-dimensional recognition, the result of three-dimensional recognition is outputted. While the result of three-dimensional recognition is not obtained, the result of two-dimensional recognition combined with tracking of a feature point is outputted. In other words, the result of tracking of a feature point is used in two-dimensional recognition, so that the result of two-dimensional recognition can be brought close to the result of three-dimensional recognition. Thus, recognition can be accurately performed with a high frequency of update as compared with two-dimensional recognition alone.

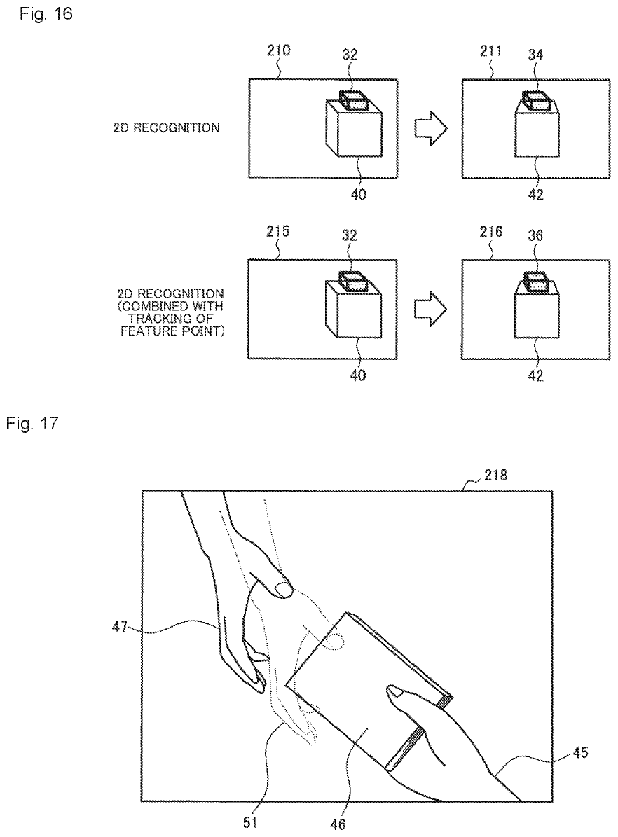

Referring to FIG. 16, the display of a virtual object on the basis of two-dimensional recognition combined with tracking of a feature point will be described below. The upper row of FIG. 16 illustrates virtual objects displayed only based on two-dimensional recognition. In a display image 210, a virtual object 32 superimposed on a real object 40 is displayed. In this case, when the user is moving, the position and orientation of a real object 42 are changed as illustrated in a display image 211. In the case of two-dimensional recognition alone, only the position of a virtual object 34 to be superimposed is correctly updated but the orientation thereof is unnaturally updated.

The lower row of FIG. 16 illustrates virtual objects displayed based on two-dimensional recognition combined with tracking of a feature point. In a display image 215, the virtual object 32 superimposed on the real object 40 is displayed. In this case, when the user is moving, the position and orientation of the real object 42 are changed as illustrated in a display image 216. The view drawing unit 103 draws a virtual object by estimating a change of the orientation through two-dimensional recognition combined with tracking of a feature point, thereby displaying a virtual object 36 while reducing artificiality in the orientation.

The view drawing unit 103 may only perform two-dimensional recognition combined with tracking of a feature point.

### <2-4. Support for Tactile Sense Mismatch>

Support for a tactile sense mismatch according to the present embodiment will be described below. The tactile sense mismatch can be caused by the delay processing (high-delay processing) of view display.

If the delay processing (high-delay processing) of view display according to the present embodiment is performed to reduce the display delay of a virtual object, a view image displayed on the display unit 150 is delayed from the scenery of a real space. This may cause a mismatch between a visual sense and a tactile sense, for example, no touch may be viewed in a view image but a touch may be felt on an object in a real space. FIG. 17 is an explanatory drawing of a state of a mismatch between a visual sense and a tactile sense. FIG. 17 illustrates a display image 218 (view image). As an example, it is assumed that a book or the like actually held by the user is handed to the other person.

A virtual object is not illustrated in FIG. 17. It is assumed that the delay processing (high-delay processing) of view display is applied according to the present embodiment. Thus, the display image 218 displayed on the display unit 150 is delayed from the scenery of a real space. Thus, when the user is handing a book 46 held with a hand 45 to a hand 47 of the other person, the book 46 may be touched with a hand 51 of the other person in a real space while the book 46 has not been touched with the hand 47 of the other person in the display image 218. At this point, the user feels a resistance or vibrations from the book 46, resulting in a mismatch between a visual sense and a tactile sense.

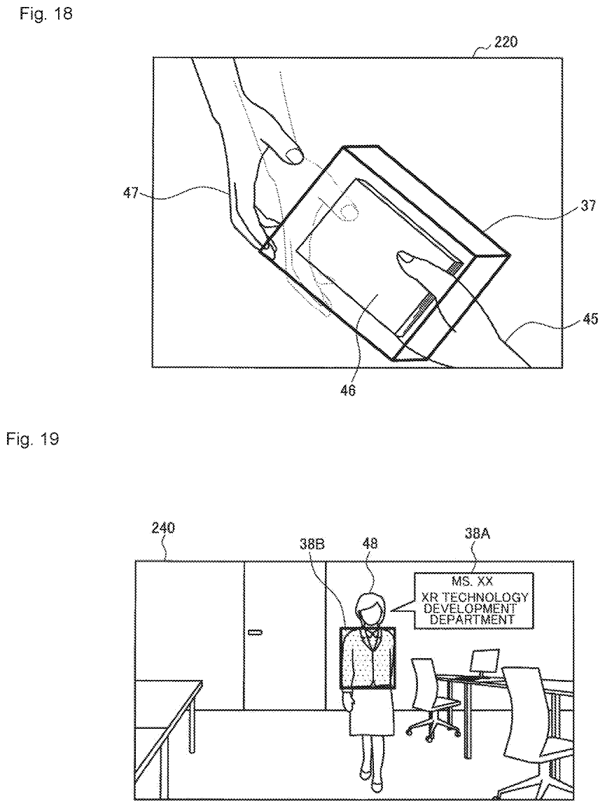

Thus, in the present embodiment, control is performed to display a virtual object for assisting a visual sense to eliminate a tactile sense mismatch, as an example of support for a tactile sense mismatch. FIG. 18 is an explanatory drawing illustrating an example of support for a tactile sense mismatch according to the present embodiment. As illustrated in FIG. 18, the control unit 100 displays a frame image 37 (virtual object) around the book 46 in a display image 220 (view image), thereby visually assisting a touch with the hand 47 of the other person. The displayed frame image 37 is so large as to be touched with the hand 47 of the other person. Thus, the user recognizes that the frame image 37 of the book 46 actually held by the user is touched with the hand 47 of the other person, thereby reducing a mismatch with a tactile sense. The size of the frame image 37 changes according to the position of the hand 47 of the other person. The control unit 100 recognizes, from the recognition or the like of a captured image in a real space, that at least a part of a user's body comes into contact with an object in the real space, and performs control such that a virtual object for visually assisting a touch with the object is superimposed on a view image. The shape of the virtual object for visually assisting a touch is not limited to the example of FIG. 18.

Likewise, a mismatch may occur between a hearing sense and a visual sense. Also in this case, as an example of support for a hearing sense mismatch, the control unit 100 can perform control such that a virtual object for visually assisting a hearing sense is superimposed on a view image. For example, the display of a virtual object for visually assisting a touch can assist a touch sound at the same time.

### <2-5. Reduction in Display Delay for Each Virtual Object>

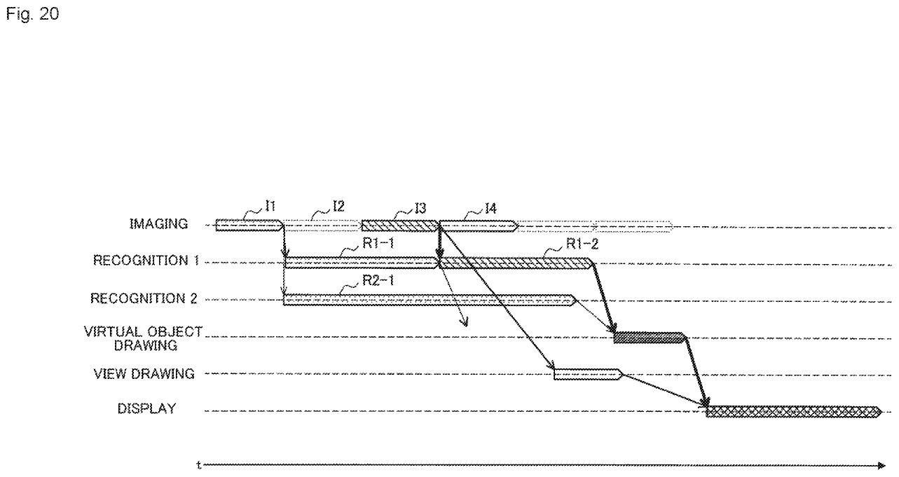

The control unit 100 according to the present embodiment can further reduce a display delay for each virtual object by using a different recognition algorithm (at least a different recognition time) for each object to be recognized. This will be described with reference to FIGS. 19 and 20.

FIG. 19 illustrates a display example of a plurality of virtual objects according to the present embodiment. As illustrated in FIG. 19, in a display image 240 (view image), a virtual object 38A and a virtual object 38B are displayed as an example. The virtual object 38A is, for example, an image of information including the name and the department of a person 48 and is displayed around the person 48. The virtual object 38B is, for example, an image displayed while being superimposed on the body of the person 48. The virtual object 38B may be, for example, an image of virtual clothes and accessories or the like.

In this case, the virtual object 38B is displayed while being superimposed on the body of the person 48. The display delay of the virtual object 38B from a real object (person 48) is desirably minimized as compared with the virtual object 38A. In other words, the virtual object 38A with a somewhat large display delay hardly causes unnaturalness.

Thus, in the present embodiment, a recognition algorithm having a shorter processing time is used for recognition for displaying the superimposed virtual object 38B, thereby reducing the display delay of the virtual object 38B from a real object. The following provides a specific description with reference to FIG. 20.

FIG. 20 is a timing chart indicating the flow of a series of processing to explain display control that is performed using a plurality of recognition algorithms in the information processor according to the present embodiment. As indicated in FIG. 20, the recognition unit 101 performs recognition 1 and recognition 2 on a captured image that is acquired by imaging I.

For example, the recognition 1 and the recognition 2 are recognition algorithms having different recognition times. The virtual object drawing unit 102 then acquires the result of recognition R1-2 by the recognition 1 and the result of recognition R2-1 by the recognition 2 when drawing a virtual object. The result of the recognition R1-2 is the recognition of a captured image that is acquired by the imaging I3, and the result of the recognition R2-1 is the recognition of a captured image that is acquired by the imaging I1 before the imaging I3. Specifically, the recognition R2-1 is based on a captured image that is acquired before a captured image of the recognition R1-2. Thus, the display delay of a virtual object, which is drawn on the basis of the result of the recognition R2-1, from a view image (e.g., the view image is a captured image that is acquired by the imaging I3) is larger than the display delay of a virtual object drawn on the basis of the result of the recognition R1-2.

Thus, the virtual object drawing unit 102 draws the virtual object 38B, which is to be provided with a smaller display delay, on the basis of the result of the recognition R1-2, and draws the virtual object 38A, which hardly causes unnaturalness even with a larger display delay than the virtual object 38B, on the basis of the result of the recognition R2-1. This can properly reduce the display delay of each of the virtual objects. In the recognition 2, a recognition algorithm may be used for recognizing only a real object related to the drawing of a virtual object using the result of the recognition.

### 3. CONCLUSION

As described above, in the embodiment of the present disclosure, the display delay of a virtual object can be properly reduced depending on the situation.

The preferred embodiment of the present disclosure has been described in detail with reference to the accompanying drawings. The present technique is not limited to such examples. It is apparent that those having ordinary knowledge in the technical field of the present disclosure could conceive various modified examples or changed examples within the scope of the technical ideas set forth in the claims, and it should be understood that these also naturally fall within the technical scope of the present disclosure.

For example, a computer program for performing the functions of the information processor 10 can be also created in hardware such as a CPU, ROM, and RAM in the information processor 10. A computer-readable storage medium in which the computer program is stored is also provided.

The effects described in the present specification are merely explanatory or exemplary and are not intended as limiting. In other words, the technique according to the present disclosure may exhibit other effects apparent to those skilled in the art from the description herein, in addition to or in place of the above effects.

The present technique can also be configured as follows:

(1)

An information processor including a display control unit, wherein the display control unit controls a video see-through display configured to display a captured image that is acquired by an imaging unit,

the display control unit superimposes a virtual object on a first captured image if a load of recognition of a real space based on a predetermined captured image is a first load, the virtual object being drawn on the basis of recognition of the real space, and

the display control unit superimposes the virtual object on a second captured image if the load of the recognition is a second load greater than the first load, the second captured image being acquired before the first captured image.

(2)

The information processor according to (1), wherein each of the first load and the second load is related to a time required for the recognition.

(3)

The information processor according to (2), wherein first load corresponds to a case where the time required for the recognition is equal to or shorter than a time for drawing the captured image that is acquired by the imaging unit, and the second load corresponds to a case where the time required for the recognition is longer than a time for drawing the captured image that is acquired by the imaging unit.

(4)

The information processor according to any one of (1) to (3), wherein the first captured image is a through image that is acquired by the imaging unit and is displayed on the video see-through display in real time.

(5)

The information processor according to (4), wherein the second captured image is the captured image that is acquired by the imaging unit, and is a captured image prior to a predetermined number of frames before the first captured image.

(6)

The information processor according to any one of (1) to (5), wherein in the recognition, the real space is recognized on the basis of a latest captured image with respect to a start time of the recognition.

(7)

The information processor according to any one of (1) to (6), wherein the captured image to be displayed on the video see-through display and the predetermined captured image to be subjected to the recognition are different captured images at different imaging times.

(8)

The information processor according to any one of (1) to (7), wherein the display control unit superimposes the virtual object on the first captured image under predetermined conditions even if the load of the recognition is the second load greater than the first load.

(9)

The information processor according to (8), wherein the predetermined conditions are related to a moving velocity of the information processor provided with the imaging unit and the video see-through display.

(10)

The information processor according to (8) or (9), wherein the predetermined conditions are related to a distance between the information processor provided with the imaging unit and the video see-through display and a moving object present in the real space.

(11)

The information processor according to any one of (1) to (10), wherein the display control unit performs switching control for switching from second processing that displays the second captured image on the video see-through display and superimposes the virtual object on the second captured image to first processing that displays the first captured image on the video see-through display and superimposes the virtual object on the first captured image.

(12)

The information processor according to (11), wherein in the switching control, processing is performed to gradually deform the captured image to be displayed on the video see-through display, from the second captured image to the first captured image on the basis of a latest own position of the information processor.

(13)

An information processing method including:

causing a processor to perform display control of a video see-through display configured to display a captured image that is acquired by an imaging unit;

causing the processor to perform display control to superimpose a virtual object on a first captured image if a load of recognition of a real space based on a predetermined captured image is a first load, the virtual object being drawn on the basis of recognition of the real space; and

causing the processor to perform display control to superimpose the virtual object on a second captured image if the load of the recognition is a second load greater than the first load, the second captured image being acquired before the first captured image.

(14)

A storage medium in which a program is stored, the program causing a computer to function as a display control unit,

wherein the display control unit controls a video see-through display configured to display a captured image that is acquired by an imaging unit,

the display control unit superimposes a virtual object on a first captured image if a load of recognition of a real space based on a predetermined captured image is a first load, the virtual object being drawn on the basis of recognition of the real space, and

the display control unit superimposes the virtual object on a second captured image if the load of the recognition is a second load greater than the first load, the second captured image being acquired before the first captured image.

### REFERENCE SIGNS LIST

10 Information processor
100 Control unit
101 Recognition unit
102 Virtual object drawing unit
103 View drawing unit
104 Display processing unit
110 Communication unit
120 Camera
130 Operation input unit
140 Sensor unit
150 Display unit
160 Speaker
170 Storage unit

1. An information processing apparatus comprising a display control unit, wherein the display control unit controls a video see-through display configured to display a captured image that is acquired by an imaging unit,
the display control unit superimposes a virtual object on a first captured image if a load of recognition processing of a real space based on a predetermined captured image is a first load, the virtual object being drawn on a basis of recognition processing of the real space, and
the display control unit superimposes the virtual object on a second captured image if the load of the recognition processing is a second load greater than the first load, the second captured image being acquired before the first captured image.

2. The information processing apparatus according to claim 1, wherein each of the first load and the second load is related to a time required for the recognition processing.

3. The information processing apparatus according to claim 2, wherein first load corresponds to a case where the time required for the recognition processing is equal to or shorter than a time for drawing the captured image that is acquired by the imaging unit, and
the second load corresponds to a case where the time required for the recognition processing is longer than a time for drawing the captured image that is acquired by the imaging unit.

4. The information processing apparatus according to claim 1, wherein the first captured image is a through image that is acquired by the imaging unit and is displayed on the video see-through display in real time.

5. The information processing apparatus according to claim 4, wherein the second captured image is the captured image that is acquired by the imaging unit, and is a captured image prior to a predetermined number of frames before the first captured image.

6. The information processing apparatus according to claim 1, wherein in the recognition processing, the real space is recognized on a basis of a latest captured image with respect to a start time of the recognition processing.

7. The information processing apparatus according to claim 1, wherein the captured image to be displayed on the video see-through display and the predetermined captured image to be subjected to the recognition processing are different captured images at different imaging times.

8. The information processing apparatus according to claim 1, wherein the display control unit superimposes the virtual object on the first captured image under predetermined conditions even if the load of the recognition processing is the second load greater than the first load.

9. The information processing apparatus according to claim 8, wherein the predetermined conditions are related to a moving velocity of the information processing apparatus provided with the imaging unit and the video see-through display.

10. The information processing apparatus according to claim 8, wherein the predetermined conditions are related to a distance between the information processing apparatus provided with the imaging unit and the video see-through display and a moving object present in the real space.

11. The information processing apparatus according to claim 1, wherein the display control unit performs switching control for switching from second processing that displays the second captured image on the video see-through display and superimposes the virtual object on the second captured image to first processing that displays the first captured image on the video see-through display and superimposes the virtual object on the first captured image.

12. The information processing apparatus according to claim 11, wherein in the switching control, processing is performed to gradually deform the captured image to be displayed on the video see-through display, from the second captured image to the first captured image on a basis of a latest own position of the information processing apparatus.

13. An information processing method comprising:
causing a processing apparatus to perform display control of a video see-through display configured to display a captured image that is acquired by an imaging unit;
causing the processing apparatus to perform display control to superimpose a virtual object on a first captured image if a load of recognition processing of a real space based on a predetermined captured image is a first load, the virtual object being drawn on a basis of recognition processing of the real space; and
causing the processing apparatus to perform display control to superimpose the virtual object on a second captured image if the load of the recognition processing is a second load greater than the first load, the second captured image being acquired before the first captured image.

14. A storage medium in which a program is stored, the program causing a computer to function as a display control unit,
wherein the display control unit controls a video see-through display configured to display a captured image that is acquired by an imaging unit,
the display control unit superimposes a virtual object on a first captured image if a load of recognition processing of a real space based on a predetermined captured image is a first load, the virtual object being drawn on a basis of recognition processing of the real space, and
the display control unit superimposes the virtual object on a second captured image if the load of the recognition processing is a second load greater than the first load, the second captured image being acquired before the first captured image.
